(19) United States
(12) Patent Application Publication
(10) Pub. No.: US 2024/0339595 A1
(43) Pub. Date: Oct. 10, 2024

(54) ANODE ACTIVE MATERIAL LAYER AND ALL-SOLID-STATE BATTERY USING THE SAME

(71) Applicants: Hyundai Motor Company, Seoul (KR); Kia Corporation, Seoul (KR)

(72) Inventors: Gyeong Jun Chung, Daejeon (KR); Jong Jung Kim, Suwon (KR); Seung Hwan Moon, Hwaseong (KR); Sung Hoo Jung, Changwon (KR); So Ri Lee, Changwon (KR)

(21) Appl. No.: 18/234,206

(22) Filed: Aug. 15, 2023

(30) Foreign Application Priority Data
Apr. 6, 2023 (KR) 10-2023-0045490

(51) Int. Cl. H01M 4/36; H01M 4/133; H01M 4/134; H01M 4/38; H01M 4/587; H01M 4/62; H01M 10/0562

(52) U.S. Cl. CPC H01M 4/366; H01M 4/133; H01M 4/134; H01M 4/386; H01M 4/587; H01M 4/623; H01M 10/0562; H01M 2004/021; H01M 2004/027; H01M 2220/20; H01M 2300/0068

(57) ABSTRACT

Disclosed is an all-solid-state battery including an anode active material layer capable of generating high power.

### CROSS-REFERENCE TO RELATED APPLICATION

This application claims, under 35 U.S.C. § 119(a), the benefit of priority from Korean Patent Application No. 10-2023-0045490, filed on Apr. 6, 2023, the entire contents of which are incorporated herein by reference.

### TECHNICAL FIELD

The present disclosure provides to an all-solid-state battery including an anode active material layer capable of generating high power.

### BACKGROUND

An all-solid-state battery includes a cathode on a cathode current collector, an anode on an anode current collector, and a solid electrolyte therebetween. The cathode includes a cathode active material containing lithium that expresses battery capacity, and the anode includes an anode active material that serves as a host for lithium. Each of the cathode and the anode further includes a solid electrolyte responsible for movement of lithium, a conductive material involved in electron conduction, and a binder binding the above elements.

Energy density, power characteristics, lifespan characteristics, etc. are required for batteries. In particular, lithium ions must be able to move efficiently in electrodes for high power performance.

Recently, research into application of silicon-based anode active materials for high energy density of all-solid-state batteries is ongoing. The anode using the silicon-based anode active material is advantageous in that a conventional lithium ion battery process may be used as is. However, the silicon-based anode active material may rapidly expand and contract in volume during charging and discharging and may lose contact with the solid electrolyte, so the movement path of lithium ions may be broken and the silicon-based anode active material may be pulverized due to stress at the interface. In particular, when a high power current is applied, non-uniform volume expansion of the silicon-based anode active material may occur inside the anode, and the lifespan of the battery may be rapidly reduced.

### SUMMARY

In preferred aspects, provided are, inter alia, an anode active material layer and an all-solid-state battery including the same. Preferably, the all-solid-state batter may have substantially improved power.

A term “all-solid-state battery” as used herein refers to a rechargeable secondary battery that includes an electrolyte in a solid state, for transferring lithium ions between the electrodes of the battery.

In an aspect, provided is an all-solid-state battery including an anode current collector, an anode active material layer, a solid electrolyte layer, a cathode active material layer, and a cathode current collector, which are stacked. In certain aspect, the all-solid-state battery includes an anode current collector, an anode active material layer disposed on the anode current collector, a solid electrolyte layer disposed on the anode active material layer, a cathode active material layer disposed on the solid electrolyte layer, and a cathode current collector disposed on the cathode active material layer.

The anode active material layer includes a first layer disposed on the anode current collector and a second layer disposed on the solid electrolyte layer.

The first layer may include a first anode active material, a first solid electrolyte, and a first binder.

The second layer may include a second anode active material, a second solid electrolyte, and a second binder.

A ratio (T₁/T₂) of a thickness (T₁) of the first layer to a thickness (T₂) of the second layer may be in a range of about 0.375 to 0.5.

A ratio (M₁/M₂) of a weight (M₁) of the first solid electrolyte in the anode active material layer to a weight (M₂) of the second solid electrolyte in the anode active material layer may be in a range of about 0.1 to 0.25.

The anode active material layer may include a first surface in contact with the anode current collector and a second surface in contact with the solid electrolyte layer, the first layer may form the first surface, and the second layer may form the second surface.

The first anode active material may include one or more selected from the group consisting of a silicon-based anode active material, and a carbon-based anode active material.

The first solid electrolyte may include a sulfide-based solid electrolyte.

The first binder may include one or more selected from the group consisting of styrene butadiene rubber, nitrile butadiene rubber, butadiene rubber.

The thickness of the first layer may be in a range of about 15 μm to 20 μm.

The first layer may include the first anode active material and the first solid electrolyte in a mass ratio of about 6:4 to 7:3.

The second anode active material may include one or more selected from the group consisting of a silicon-based anode active material, and a carbon-based anode active material.

The second solid electrolyte may include a sulfide-based solid electrolyte.

The second binder may include one or more selected from the group consisting of polyvinylidene fluoride, poly(vinylidene fluoride-co-hexafluoropropylene), chlorotrifluoroethylene, and polytetrafluoroethylene.

The thickness of the second layer may be in a range of about 40 μm to 50 μm.

The second layer may include the second anode active material and the second solid electrolyte in a mass ratio of about 3:7 to 4:6.

Also provided is a vehicle that include the all-solid-state battery as described herein. Other aspects of the invention are disclosed infra.

### BRIEF DESCRIPTION OF THE DRAWINGS

The above and other features of the present invention will now be described in detail with reference to certain exemplary embodiments thereof illustrated in the accompanying drawings, which are given hereinbelow by way of illustration only, and thus are not limitative of the present invention, and wherein:

FIG. 1 shows an all-solid-state battery according to an exemplary embodiment of the present invention;

FIG. 2 shows an anode active material layer according to an exemplary embodiment of the present invention;

FIG. 3 shows results of measurement of peel strength of anode active material layers according to Examples 1 and 2 and Comparative Examples 1 to 4; and

FIG. 4 shows results of measurement of capacity retention rates of all-solid-state batteries according to Examples 1 and 2 and Comparative Examples 1 to 4.

### DETAILED DESCRIPTION

The above and other objects, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the disclosure and to sufficiently transfer the spirit of the present invention to those skilled in the art.

Throughout the drawings, the same reference numerals will refer to the same or like elements. For the sake of clarity of the present invention, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present invention. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Unless the context clearly indicates otherwise, all numbers, figures, and/or expressions that represent ingredients, reaction conditions, polymer compositions, and amounts of mixtures used in the specification are approximations that reflect various uncertainties of measurement occurring inherently in obtaining these figures, among other things. For this reason, it should be understood that, in all cases, the term “about” should be understood to modify all such numbers, figures and/or expressions. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. It should be understood that, in the specification, when a range is referred to regarding a parameter, the parameter encompasses all figures including end points disclosed within the range. For example, the range of “5 to 10” includes figures of 5, 6, 7, 8, 9, and 10, as well as arbitrary sub-ranges, such as ranges of 6 to 10, 7 to 10, 6 to 9, and 7 to 9, and any figures, such as 5.5, 6.5, 7.5, 5.5 to 8.5, and 6.5 to 9, between appropriate integers that fall within the range. In addition, for example, the range of “10% to 30%” encompasses all integers that include numbers such as 10%, 11%, 12%, and 13%, as well as 30%, and any sub-ranges, such as 10% to 15%, 12% to 18%, or 20% to 30%, as well as any numbers, such as 10.5%, 15.5%, and 25.5%, between appropriate integers that fall within the range.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

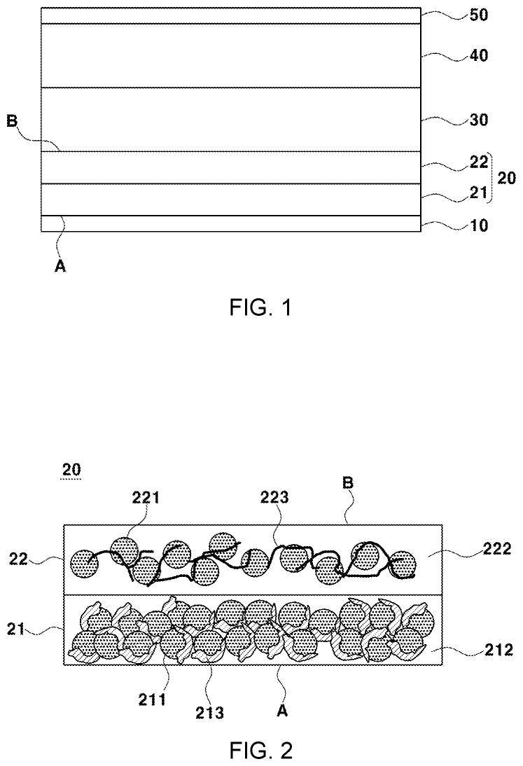

FIG. 1 shows an all-solid-state battery according to an exemplary embodiment of the present invention. For example, the all-solid-state battery includes an anode current collector 10, an anode active material layer 20 on the anode current collector 10, a solid electrolyte layer 30 on the anode active material layer 20, a cathode active material layer 40 on the solid electrolyte layer 30, and a cathode current collector 50 on the cathode active material layer 40.

The anode current collector 10 may be an electrically conductive plate-shaped substrate. For example, the anode current collector 10 may be provided in the form of a sheet, a thin film, or foil

The anode current collector 10 may include a material that does not react with lithium. For example, the anode current collector 10 may include one or more selected from the group consisting of nickel (Ni), copper (Cu), and stainless steel.

The thickness of the anode current collector 10 is not particularly limited, and may be, for example, in a range of about 1 μm to 500 μm.

FIG. 2 shows an anode active material layer 20 according to an exemplary embodiment of the present invention. For example, the anode active material layer 20 may include a first surface A in contact with the anode current collector 10 and a second surface B in contact with the solid electrolyte layer 30. The anode active material layer 20 may include a first layer 21 disposed on the anode current collector 10 and configured to form the first surface A and a second layer 22 disposed on the solid electrolyte layer 30 and configured to form the second surface B.

The first layer 21 and the second layer 22 may include different types of binders and include the solid electrolyte and the anode active material at different ratios.

A conventional anode has a monolayer structure including an anode active material, a solid electrolyte, a conductive material, a binder, and the like. When a high power current is applied to the conventional anode, the volume of the anode active material included in the region adjacent to the solid electrolyte layer in the anode expands when the battery is charged. This is because the lithium ion conductivity of the region adjacent to the solid electrolyte layer is higher than that of the region adjacent to the anode current collector in the conventional anode. Due to non-uniform volume expansion of the anode active material in the anode as above, cracking may occur in the anode and durability deterioration may accelerate. In the present invention, the anode active material layer 20 is formed in a double layer configuration, but different types of binders are used and the amount of the solid electrolyte is adjusted in order to realize physical properties required for each layer.

The first layer 21 may include a first anode active material 211, a first solid electrolyte 212, and a first binder 213.

The second layer 22 may include a second anode active material 221, a second solid electrolyte 222, and a second binder 223.

Particularly, the first layer 21 may include a butadiene rubber-based binder as the first binder 213, and the second layer 22 may include a fluorine-based binder as the second binder 223.

As shown in FIG. 2, since the butadiene rubber-based binder as the first binder 213 comes into surface contact with the first anode active material 211 and the first solid electrolyte 212, the Accordingly, lithium ion conductivity and electron contact area may become increased. conductivity in the first layer 21 may be decreased, but adhesion may be increased, thus preventing the anode active material layer 20 from being separated from the anode current collector 10.

Since the fluorine-based binder as the second binder 223 comes into line contact with the second anode active material 221 and the second solid electrolyte 222, the contact area may become decreased. Therefore, adhesion within the second layer 22 is decreased, but lithium ion conductivity and electron conductivity may be increased.

In the anode active material layer 20, when the ratio (T₁/T₂) of the thickness (T₁) of the first layer 21 to the thickness (T₂) of the second layer 22 may be in a range of about 0.375 to 0.5, the ratio (M₁/M₂) of the amount (M₁) of the first solid electrolyte 212 to the amount (M₂) of the second solid electrolyte 222 may be in a range of about 0.1 to 0.25. The amount of the first solid electrolyte 212 and the amount of the second solid electrolyte may mean a weight of first solid electrolyte 212 and a weight of the second solid electrolyte, respectively. Particularly, the anode active material layer 20 may be configured such that the amount of the first anode active material 211 is increased while decreasing the amount of the first solid electrolyte 212 for the first layer 21 and the amount of the second anode active material 221 is decreased while increasing the amount of the second solid electrolyte 222 for the second layer 22.

When the butadiene rubber-based binder is used as the first binder 213 and the amount of the first solid electrolyte 212 is decreased in the first layer 21, adhesion between the first anode active material 211 and the first solid electrolyte 212 may be increased, and the anode active material layer 20 may be prevented from being separated from the anode current collector 10, thereby minimizing damage caused by various processes applied to the all-solid-state battery, such as punching, welding, etc. Moreover, since durability of the anode active material layer 20 is increased, the lifespan of the battery may be extended.

When the fluorine-based binder is used as the second binder 223 and the amount of the second solid electrolyte 222 is increased in the second layer 22, a lithium ion conduction path in the second layer 22 may be lengthened. Accordingly, cracking may be prevented from occurring at the interface between the second layer 22 and the solid electrolyte layer 30, and non-uniform volume expansion of the first layer 21 and the second layer 22 may be suppressed by alleviating the volume change in the second layer 22 during high-rate charging and discharging for an all-solid-state battery.

The first anode active material 211 may include at least one selected from the group consisting of a silicon-based anode active material, a carbon-based anode active material, and combinations thereof. Preferably, the first anode active material 211 includes a combination of a silicon-based anode active material and a carbon-based anode active material, and for example, is configured such that a core portion containing a carbon-based anode active material is coated with a shell portion containing a silicon-based anode active material.

The silicon-based anode active material may include Si, SiOₓ (0<x<2), and the like.

The carbon-based anode active material may include natural graphite, artificial graphite, and the like.

The average particle diameter (D50) of the first anode active material 211 is not particularly limited, but may be, for example, in a range of about 8 μm to 10 μm.

The first solid electrolyte 212 may include a sulfide-based solid electrolyte.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers and M is any one selected from among P, Si, Ge, B, Al, Ga, and In), Li₁₀GeP₂S₁₂, and the like.

The first binder 213 may include a butadiene rubber-based binder, and specifically, may include at least one selected from the group consisting of styrene butadiene rubber, nitrile butadiene rubber, butadiene rubber, and combinations thereof.

The first layer 21 may have a thickness of 15 μm to 20 μm, and may include the first anode active material 211 and the first solid electrolyte 212 in a mass ratio of 6:4 to 7:3. When the thickness of the first layer 21 and the amount of each component fall within the above numerical ranges, the thickness ratio with the second layer 22 and the amount ratio with the second solid electrolyte 222 may be realized.

The second anode active material 221 may be the same as or different from the first anode active material 211. The second anode active material 221 may include at least one selected from the group consisting of a silicon-based anode active material, a carbon-based anode active material, and combinations thereof. Preferably, the second anode active material 221 may include a combination of a silicon-based anode active material and a carbon-based anode active material, and for example, is configured such that a core part containing a carbon-based anode active material is coated with a shell part containing a silicon-based anode active material.

The second solid electrolyte 222 may be the same as or different from the first solid electrolyte 212. The second solid electrolyte 222 may include a sulfide-based solid electrolyte.

The second binder 223 may include a fluorine-based binder, and specifically, may include at least one selected from the group consisting of polyvinylidene fluoride, poly(vinylidene fluoride-co-hexafluoropropylene), chlorotrifluoroethylene, polytetrafluoroethylene, and combinations thereof.

The second layer 22 may have a thickness of 40 μm to 50 μm, and may include the second anode active material 221 and the second solid electrolyte 222 in a mass ratio of about 3:7 to 4:6. When the thickness of the second layer 22 and the amount of each component fall within the above numerical ranges, the thickness ratio with the first layer 21 and the amount ratio with the first solid electrolyte 212 may be realized.

The solid electrolyte layer 30 may be interposed between the anode active material layer 20 and the cathode active material layer 40 and may include a solid electrolyte having lithium ion conductivity.

The solid electrolyte may include an oxide-based solid electrolyte, a sulfide-based solid electrolyte, and the like.

Examples of the oxide-based solid electrolyte may include perovskite-type LLTO (Li₃ₓLa_{2/3-x}TiO₃), phosphate-based NASICON-type LATP (Li₁₋ₓAlₓTi₂₋ₓ(PO₄)₃), and the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers and M is any one selected from among P, Si, Ge, B, Al, Ga, and In), Li₁₀GeP₂S₁₂, and the like.

The cathode active material layer 40 may include a cathode active material, a solid electrolyte, a conductive material, a binder, and the like.

The cathode active material may occlude and release lithium ions.

The cathode active material may include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one selected from among Al, Mg, Co, Fe, Ni and Zn, 0<x+y<2), lithium titanate such as Li₄Ti₅O₁₂, and the like.

The solid electrolyte may include an oxide-based solid electrolyte or a sulfide-based solid electrolyte. Preferably, the sulfide-based solid electrolyte having high lithium ion conductivity may be used as the solid electrolyte. Although the sulfide-based solid electrolyte is not particularly limited, examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers and M is any one selected from among P, Si, Ge, B, Al, Ga, and In), Li₁₀GeP₂S₁₂, and the like. The solid electrolyte included in the cathode active material layer 40 may be the same as or different from the solid electrolyte included in the solid electrolyte layer 30.

Examples of the conductive material may include carbon black, conductive graphite, ethylene black, graphene, and the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode current collector 50 may include a plate-shaped substrate having electrical conductivity. The cathode current collector 50 may include aluminum foil.

The thickness of the cathode current collector 50 is not particularly limited, and may be, for example, 1 μm to 500 μm.

### EXAMPLE

A better understanding of the present invention may be obtained through the following examples. These examples are merely set forth to illustrate the present invention, and are not to be construed as limiting the scope of the present invention.

### Example 1

Silicon (Si)-coated artificial graphite was used as a first anode active material. The average particle diameter (D50) of the first anode active material was 8 μm to 10 μm. A sulfide-based solid electrolyte was used as a first solid electrolyte. The first anode active material and the first solid electrolyte were mixed in a mass ratio shown in Table 1 below and dry-mixed using a P/D mixer (planetary disperser mixer).

A first slurry was obtained by adding a first binder, a dispersant, and a solvent to the result of dry mixing and performing mixing using a P/D mixer. Butadiene rubber was used as the first binder.

The first slurry was applied onto a current collector with a blade to form a first layer, and the first layer was dried at about 90° C.

As a second anode active material, the same material as the first anode active material was used. As a second solid electrolyte, the same material as the first solid electrolyte was used. The second anode active material and the second solid electrolyte were mixed in a mass ratio shown in Table 1 below and dry-mixed using a P/D mixer.

A second slurry was obtained by adding a second binder, a dispersant, and a solvent to the result of dry mixing and performing mixing using a P/D mixer. Polyvinylidene fluoride was used as the second binder.

The second slurry was applied onto the first layer with a blade to form a second layer, thereby obtaining an anode active material layer. After drying the anode active material layer at about 90° C., vacuum drying was performed at about 120° C. for about 4 hours.

The thickness ratio of the first layer and the second layer and the amount ratio of the first solid electrolyte and the second solid electrolyte are shown in Table 1 below.

An all-solid-state battery as shown in FIG. 1 was manufactured by stacking a solid electrolyte layer, a cathode active material layer, and a cathode current collector on the anode active material layer.

### Example 2

An anode active material layer and an all-solid-state battery including the same were manufactured in the same manner as in Example 1, with the exception that the thickness of the first layer, the mass ratio of the first anode active material and the first solid electrolyte in the first layer, the thickness of the second layer, the mass ratio of the second anode active material and the second solid electrolyte in the second layer, the thickness ratio of the first layer and the second layer, and the amount ratio of the first solid electrolyte and the second solid electrolyte were adjusted as shown in Table 1 below.

### Comparative Example 1

An anode active material layer and an all-solid-state battery including the same were manufactured in the same manner as in Example 1, with the exception that the thickness of the first layer, the mass ratio of the first anode active material and the first solid electrolyte in the first layer, the thickness of the second layer, the mass ratio of the second anode active material and the second solid electrolyte in the second layer, the thickness ratio of the first layer and the second layer, and the amount ratio of the first solid electrolyte and the second solid electrolyte were adjusted as shown in Table 1 below.

### Comparative Example 2

An anode active material layer and an all-solid-state battery including the same were manufactured in the same manner as in Example 1, with the exception that the thickness of the first layer, the mass ratio of the first anode active material and the first solid electrolyte in the first layer, the thickness of the second layer, the mass ratio of the second anode active material and the second solid electrolyte in the second layer, the thickness ratio of the first layer and the second layer, and the amount ratio of the first solid electrolyte and the second solid electrolyte were adjusted as shown in Table 1 below.

### Comparative Example 3

An anode active material layer and an all-solid-state battery including the same were manufactured in the same manner as in Example 1, with the exception that butadiene rubber was used as the second binder, and the thickness of the first layer, the mass ratio of the first anode active material and the first solid electrolyte in the first layer, the thickness of the second layer, the mass ratio of the second anode active material and the second solid electrolyte in the second layer, the thickness ratio of the first layer and the second layer, and the amount ratio of the first solid electrolyte and the second solid electrolyte were adjusted as shown in Table 1 below.

### Comparative Example 4

An anode active material layer and an all-solid-state battery including the same were manufactured in the same manner as in Example 1, with the exception that polytetrafluoroethylene was used as the first binder, and the thickness of the first layer, the mass ratio of the first anode active material and the first solid electrolyte in the first layer, the thickness of the second layer, the mass ratio of the second anode active material and the second solid electrolyte in the second layer, the thickness ratio of the first layer and the second layer, and the amount ratio of the first solid electrolyte and the second solid electrolyte were adjusted as shown in Table 1 below.

TABLE 1

| | Comparative | | | Comparative | Comparative | Comparative |
|---|---|---|---|---|---|---|
| Items | Example 1 | Example 1 | Example 2 | Example 2 | Example 3 | Example 4 |
| Thickness of | 10 | 20 | 15 | 20 | 30 | 30 |
| first layer | | | | | | |
| [μm] | | | | | | |
| Thickness of | 40 | 40 | 40 | 40 | 30 | 30 |
| second layer | | | | | | |
| [μm] | | | | | | |
| Mass ratio of | 8:2 | 7:3 | 6:4 | 5:5 | 5:5 | 5:5 |
| first anode | | | | | | |
| active | | | | | | |
| material and | | | | | | |
| first solid | | | | | | |
| electrolyte | | | | | | |
| Mass ratio of | 3:7 | 4:6 | 4:6 | 5:5 | 5:5 | 5:5 |
| second anode | | | | | | |
| active | | | | | | |
| material and | | | | | | |
| second solid | | | | | | |
| electrolyte | | | | | | |
| T₁/T₂* | 0.25 | 0.5 | 0.375 | 0.5 | 1.0 | 1.0 |
| M₁/M₂** | 0.07 | 0.25 | 0.25 | 0.5 | 1.0 | 1.0 |
| First binder | Butadiene | Butadiene | Butadiene | Butadiene | Butadiene | PTFE |
| | rubber | rubber | rubber | rubber | rubber | |
| Second binder | PTFE | PTFE | PTFE | PTFE | Butadiene | PTFE |
| | | | | | rubber | |

*Ratio (T₁/T₂) of thickness (T₁) of first layer to thickness (T₂) of second layer
**Ratio (M₁/M₂) of amount (M₁) of first solid electrolyte in anode active material layer to amount (M₂) of second solid electrolyte in anode active material layer

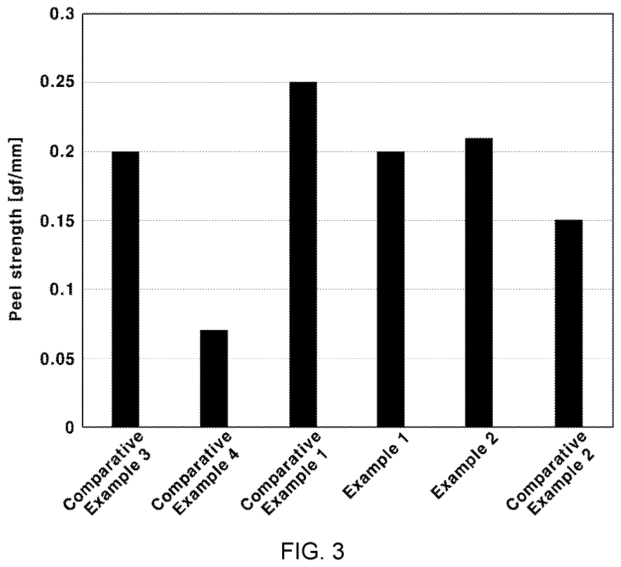

FIG. 3 shows results of measurement of peel strength of the anode active material layers according to Examples 1 and 2 and Comparative Examples 1 to 4. The peel strength of each anode active material layer was measured through peeling at a rate of 10 mm/min at room temperature using a tensile tester (DYM-02) according to ASTM D903.

Based on the results of Comparative Example 3 and Examples 1 and 2 of FIG. 3, even when the butadiene rubber-based binder was used as the first binder and the fluorine-based binder was used as the second binder as in Examples 1 and 2, peel strength equivalent to that of Comparative Example 3 using the butadiene rubber-based binder as both the first binder and the second binder was exhibited. In contrast, based on the results of Comparative Example 4 and Examples 1 and 2, peel strength was greatly reduced when the fluorine-based binder was used as the first binder as in Comparative Example 4.

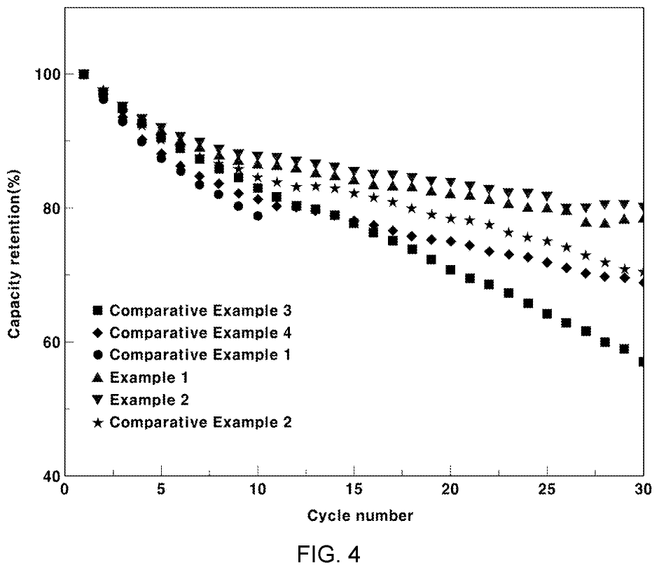

FIG. 4 shows results of measurement of capacity retention rates of all-solid-state batteries according to Examples 1 and 2 and Comparative Examples 1 to 4. Each all-solid-state battery was charged and discharged under conditions of a voltage of 2.5-4.25 V, a current of 0.2 C (8.6 mA), and a temperature of 30° C., and the capacity retention rate thereof was measured.

As shown in FIG. 4, Examples 1 and 2 satisfying the thickness ratio of the first layer and the second layer and the amount ratio of the first solid electrolyte and the second solid electrolyte described herein exhibited high capacity retention rates compared to Comparative Examples 1 to 4. In particular, a short circuit occurred after about 10 charge/discharge cycles in Comparative Example 1.

According to various exemplary embodiments of the present disclosure, according to the present invention, an all-solid-state battery with high power can be obtained.

The effects of the present invention are not limited to the above-mentioned effects. It should be understood that the effects of the present invention include all effects that can be inferred from the description of the present invention.

As the embodiments of the present invention have been described in detail above, the scope of the present invention is not limited to the above-described embodiments, and various modifications and improvements made by those skilled in the art using the basic concept of the present invention defined in the following claims are also included in the scope of the present invention.

What is claimed is:

1. An all-solid-state battery, comprising:
an anode current collector,
an anode active material layer disposed on the anode current collector,
a solid electrolyte layer disposed on the anode active material layer,
a cathode active material layer disposed on the solid electrolyte layer, and
a cathode current collector disposed on the cathode active material layer,
wherein the anode active material layer comprises a first layer disposed on the anode current collector and a second layer disposed on the solid electrolyte layer,
the first layer comprises a first anode active material, a first solid electrolyte, and a first binder,
the second layer comprises a second anode active material, a second solid electrolyte, and a second binder,
a ratio (T₁/T₂) of a thickness (T₁) of the first layer to a thickness (T₂) of the second layer is in a range of 0.375 to 0.5, and
a ratio (M₁/M₂) of a weight (M₁) of the first solid electrolyte in the anode active material layer to a weight (M₂) of the second solid electrolyte in the anode active material layer is in a range of 0.1 to 0.25.

2. The all-solid-state battery of claim 1, wherein the anode active material layer comprises a first surface in contact with the anode current collector and a second surface in contact with the solid electrolyte layer, the first layer forms the first surface, and the second layer forms the second surface.

3. The all-solid-state battery of claim 1, wherein the first anode active material comprises one or more selected from the group consisting of a silicon-based anode active material, and a carbon-based anode active material.

4. The all-solid-state battery of claim 1, wherein the first solid electrolyte comprises a sulfide-based solid electrolyte.

5. The all-solid-state battery of claim 1, wherein the first binder comprises one or more selected from the group consisting of styrene butadiene rubber, nitrile butadiene rubber, and butadiene rubber.

6. The all-solid-state battery of claim 1, wherein the thickness of the first layer is in a range of 15 μm to 20 μm.

7. The all-solid-state battery of claim 1, wherein the first layer comprises the first anode active material and the first solid electrolyte in a mass ratio of 6:4 to 7:3.

8. The all-solid-state battery of claim 1, wherein the second anode active material comprises one or more selected from the group consisting of a silicon-based anode active material, and a carbon-based anode active material.

9. The all-solid-state battery of claim 1, wherein the second solid electrolyte comprises a sulfide-based solid electrolyte.

10. The all-solid-state battery of claim 1, wherein the second binder comprises one or more selected from the group consisting of polyvinylidene fluoride, poly(vinylidene fluoride-co-hexafluoropropylene), chlorotrifluoroethylene, and polytetrafluoroethylene.

11. The all-solid-state battery of claim 1, wherein the thickness of the second layer is in a range of 40 μm to 50 μm.

12. The all-solid-state battery of claim 1, wherein the second layer comprises the second anode active material and the second solid electrolyte in a mass ratio of 3:7 to 4:6.

13. A vehicle comprising an all-solid-state battery of claim 1.
